(19) United States
(12) Patent Application Publication
(10) Pub. No.: US 2008/0138556 A1
(43) Pub. Date: Jun. 12, 2008

(54) MULTI-PLY LINERLESS CONSTRUCTIONS AND METHODS OF PRODUCING THE SAME

(75) Inventors: David R. Emmert, Pleasant Lake, IN (US); Brian Hamrick, Angola, IN (US); John T. Soma, Rochester Hills, MI (US)

Correspondence Address: HANLEY, FLIGHT & ZIMMERMAN, LLC, 150 S. WACKER DRIVE, SUITE 2100, CHICAGO, IL, 60606, US

(73) Assignee: MOORE WALLACE NORTH AMERICA, INC., Stamford, CT (US)

(21) Appl. No.: 11/567,320

(22) Filed: Dec. 6, 2006

(51) Int. Cl. B32B 33/00; B05D 5/10

(52) U.S. Cl. 428/41.8; 427/207.1

(57) ABSTRACT

Multi-ply linerless constructions and related methods of manufacturing the same are disclosed. An example multi-ply linerless construction includes a first layer that has a first face including a first adhesive pattern and a second face including a first release coating. The construction further includes a second layer that has a third face including a second adhesive pattern and a fourth face including a second release coating. The second face and the third face are releasably coupled to releasably couple the first layer and the second layer. Upon a separation of the first layer and the second layer, each of the first layer and the second layer is a form that provides at least one of graphic images, graphic information, textual images or textual information.

### FIELD OF THE DISCLOSURE

The present disclosure relates generally to multiple layer constructions and, more particularly, to multi-ply linerless constructions and methods of producing the same.

### BACKGROUND

Typically, multiple layer constructions such as, for example, labels, include a base layer or label and an upper layer or labels attached thereto. When the upper layer includes multiple labels, the labels are typically applied in series to the base layer as the base layer moves through manufacturing equipment. Precise placement of the labels is critical and misalignment of the labels relative to the base layer may later lead to printing and/or cutting errors.

One known method that attempted to ensure proper alignment of a layer of upper labels on a base layer of labels is described in U.S. Pat. No. 6,858,108. The method described therein provides that an upper web including a series of upper labels is unwound and provided with a series of transverse pairs of openings located along the web that that defines the upper labels. A base web is then joined to the bottom of the upper web. An adhesive overlaminate is applied to the top of the upper layer of the web and traverses through the upper layer at the openings. Thus, the adhesive overlaminate holds the upper layer to the base layer via spots of adhesive through the openings in the upper layer. The layers are then die cut and/or otherwise treated. Then a waste matrix formed outside the die cut areas is removed to put the labels in their final form.

Though the above-described method attempts to enable proper alignment of two layers of labels, the method has several disadvantages. Namely, the method requires additional steps to form the transverse pairs of openings, which increases production time and costs. Also, the method results in the production of a waste matrix and, as a result, the upper layer and the base layer are not used to optimum efficiency. Creation of a waste matrix also increases production costs as the waste has to be disposed of or recycled upon its removal from the final product.

### BRIEF DESCRIPTION OF THE DRAWINGS

FIG. 1 is a schematic view of a portion of an example multi-ply linerless construction being peeled apart.

FIG. 2 is an exploded view of the example multi-ply linerless construction of FIG. 1.

FIG. 3 is another exploded view of the example multi-ply linerless construction of FIG. 1.

FIG. 4A is a cross-sectional view of the example multi-ply linerless construction of FIG. 1 taken along the 4A-4A line.

FIG. 4B is a cross-sectional view of the example multi-ply linerless construction of FIG. 1 taken along the 4B-4B line.

FIG. 5 is a cross-sectional view of an example multi-ply linerless construction having three base layers.

FIG. 6 is flow chart of an example method of producing the example multi-ply linerless construction of FIG. 1.

### DETAILED DESCRIPTION

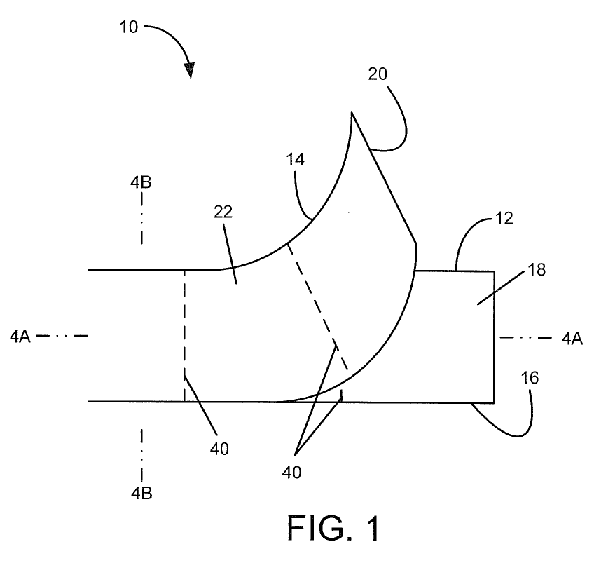

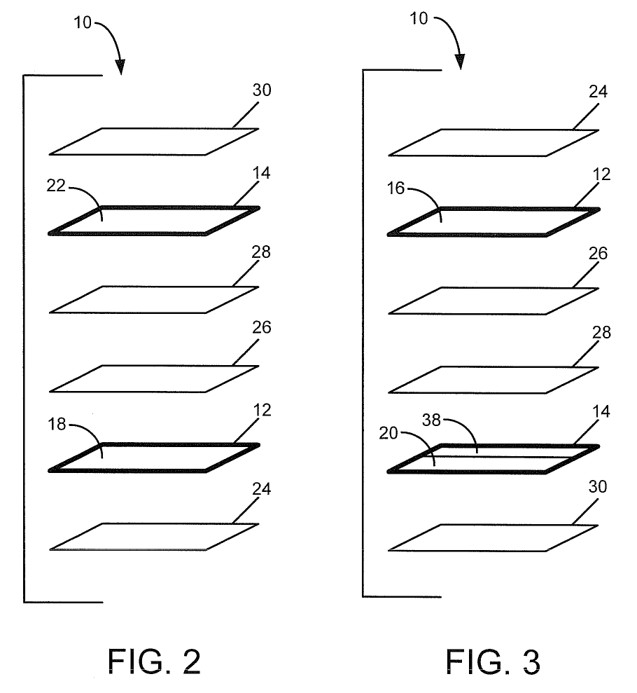

An example method of manufacturing and articles of manufacture for a multi-ply linerless construction are disclosed herein and shown in FIGS. 1-6. An example multi-ply linerless construction includes a first layer that has a first face having a first adhesive pattern and a second face having a first release coating. The construction further includes a second layer that has a third face having a second adhesive pattern and a fourth face having a second release coating. The second face and the third face are releasably coupled to releasably couple the first layer and the second layer. In addition, upon a separation of the first layer and the second layer, each of the first layer and the second layer may be used as a form that provides at least one of graphic images, graphic information, textual images or textual information.

FIGS. 1-4 show an example multi-ply linerless construction 10. The multi-ply linerless construction 10 includes a first layer 12 and a second layer 14. The first layer 12 includes a first face 16 and a second face 18. The second layer 14 includes a third face 20 and a fourth face 22. The first face 16 of the first layer 12 has a first adhesive pattern 24 formed thereon, and the second face 18 of the first layer 12 has a first release coating 26 formed thereon. Similarly, the third face 20 of the second layer 14 has a second adhesive pattern 28 formed thereon, and the fourth face 22 of the second layer 14 has a second release coating 30 formed thereon. When the multi-ply linerless construction 10 is assembled, the first release coating 26 is coupled to the second adhesive pattern 28, which releasably couples the first layer 12 and the second layer 14 via the second face 18 and the third face 20.

As described in greater detail below, the first layer 12 and the second layer 14 also may be releasably couplable via the first face 16 and the fourth face 22. More specifically, the multi-ply linerless construction 10 may be rolled up such as, for example, to facilitate transport of a long portion or web of the multi-ply linerless construction 10. When the multi-ply linerless construction 10 is rolled, a front or leading edge of the multi-ply linerless construction 10 is rolled over so that the first adhesive pattern 24 on the first face 12 of the first layer 12 is positioned against the second release coating 30 on the fourth face 22 of the second layer 14.

FIG. 5 shows another example multi-ply linerless construction 13 having a third layer 32. The remaining layers of the example multi-layer construction 13 of FIG. 5 are similar or identical to those of FIGS. 1-4 to which their reference numbers correspond. As depicted in FIG. 5, the third layer 32 has a fifth face 33 on which a third adhesive pattern 34 is formed, and a sixth face 35 on which a third release coating 36 is formed. The third adhesive pattern 34 is releasably couplable to the second release coating 30 to releasably couple the second layer 14 to the third layer 32. In addition, the multi-ply linerless construction 13 may be rolled so the first face 16 is opposite the sixth face 35 and the first adhesive pattern 24 is releasably coupled to the third release coating 36 to releasably couple the first layer 12 and the third layer 32. Though example constructions with two layers (FIGS. 1-4) and three layers (FIG. 5) are shown, any number of layers may be included to create a multi-ply linerless construction having any desired number of layers.

In the examples described herein, the release coating layers may be any of a variety of commercially available release coatings such as, for example, a silicone-based release coating. In addition, the adhesive layers may include any of a number of known available adhesives such as, for example, a hot melt pressure sensitive adhesive, a repositionable adhesive, a water-based adhesive, a cohesive, and/or fugitive adhesive, etc.

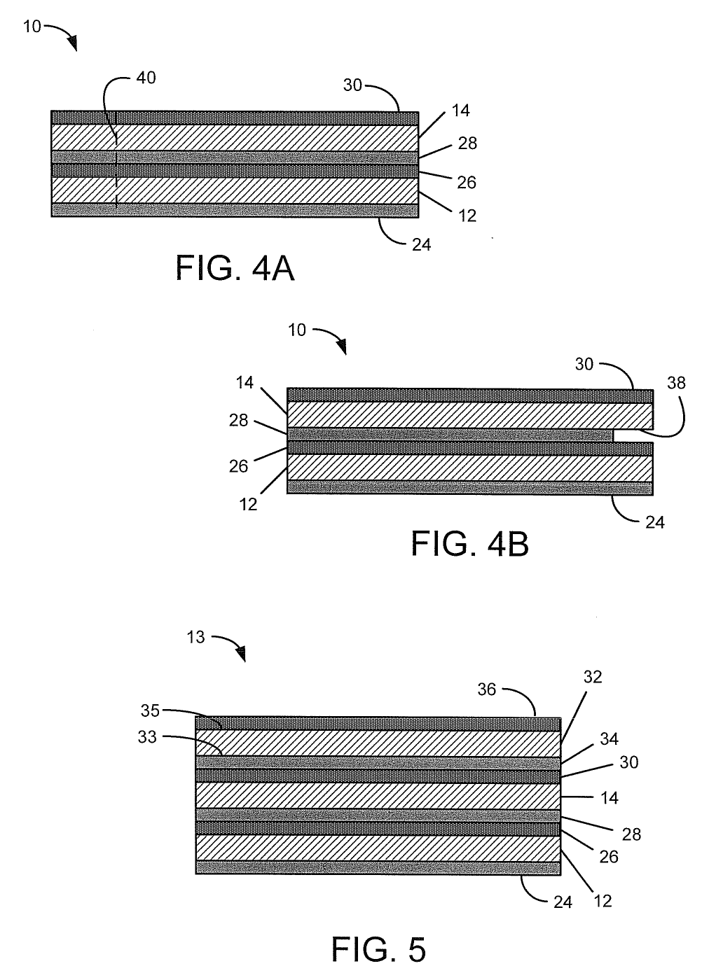

In the illustrated example multi-ply linerless constructions 10 and 13, the first adhesive pattern 24 covers substantially all of the first face 16, the first release coating 26 covers substantially all of the second face 18, the second adhesive pattern 28 covers substantially all of the third face 20, and the second release coating 30 covers substantially all of the fourth face 22. However, any other type of adhesive and release coating patterns may be used instead, including, for example, strips, dots, or any other pattern or design covering a portion of the faces 16, 18, 20 and 22. In addition, a portion of the third face 20 of the second layer 14 such as, for example, an area or strip 38 along the edge of the third face 20, may be substantially free of the second adhesive pattern 28 (FIGS. 3 and 4B). The lack of adhesive on the area or strip 38 facilitates the separation of the first layer 12 and the second layer 14. Because the area or strip 38 does not include an adhesive pattern, the user of the multi-ply linerless label construction 10 or 13 may easily manipulate the multi-ply linerless label construction 10 or 13 to begin the separation of the second adhesive pattern 28 from the first release coating 26 and the first layer 12 from the second layer 14. The first face 16, fifth face 33, etc. may also have a portion that is substantially free of the first and third adhesive patterns 24 and 34, respectively. In any case, where there is no adhesive pattern 24 or 28, there is no need for a corresponding release coating 30 and 26, respectively.

Prior to separating the second face 18 of the first layer 12 and the third face 20 of the second layer 14, the user, which may be, for example, an intermediary manufacturer, distributor, retailer, etc., may unroll the wound portion of the multi-ply linerless construction 10 or 13 to flatten the multi-ply linerless construction 10 or 13 to separate the first face 16 from the fourth face 22. Once the first face 16 and the fourth face 22 are separated, the second face 18 and the third face 20 may be, for example, separated with the aid of the area or strip 38. After the first layer 12 and the second layer 14 are separated, each of the layers 12 and 14 is a form that may be used for any intended purpose. For example, each of the faces 16, 18, 20 and 22 is a surface that may include human readable indicia, textual images and/or information, instructions, data, and/or graphic images and/or instructions, etc. As a further example, one of the faces 16 and 18 of the first layer 12 may be used to present information in English language while the other one of the faces 16 and 18 may be used to present information in Spanish language. Alternatively, or additionally, the second layer 14 may be used to present graphical-based instructions, or any other language or information detailed above. Still further, the first layer 12 may be used to present information for one purpose, and the second layer 14 may be used as a form for an unrelated purpose. In yet another alternative example, one or more of the faces 16, 18, 20 and 22 may be left blank and/or available for a future use.

Upon separation of the first layer 12 and the second layer 14, substantial portions and/or the entireties of each of the layers 12 and 14 are usable. That is, the multi-ply linerless constructions 10 and 13 are not only free of a liner, but produce or leave substantially no waste material. In other words, each of the layers 12 and 14 becomes a substantially unitary form or article that may be configured for any desired purpose(s). Some such example uses, in addition to those listed above, may include, for example, the inclusion of a coupon, a reward, a tag, a removable label, a return postcard, a warranty card, etc. In addition, at least a portion of one or more of the layers 12 and 14 may be configured as a reusable label that may be releasably adhered to another surface such, for example, an informational label for releasable adhesion or coupling to a window or other surface. To this end, at least a portion of the adhesive patterns 24 and 28 may remain with the layers 12 and 14 to enable recoupling or removable attachment of the layers 12 and/or 14 to another surface.

In some examples, the multi-ply linerless constructions 10 and 13 have substantially no lines of weakness in the first layer 12 and the second layer 14. However, in other examples, the multi-ply linerless constructions 10 and 13 may be divided into a plurality of sections by lines of weakness 40 (FIG. 1). The lines of weakness 40 may include, for example, creases, folds, die-cuts, perforations, slits and the like, or any combination thereof.

The multi-ply linerless constructions 10 and 13 may be separated along the lines of weakness 40, and the resulting sections can be sheeted or stacked into a pad or other formation for storage or transportation, for example. When the sections of the multi-ply linerless constructions 10 and 13 are stacked, the first face 16 of the first layer 12 of one section of the multi-ply linerless constructions 10 and 13 is releasably coupled or married with the second release coating 30 of the fourth face 22 of the second layer 14 of a subsequent section of the multi-ply linerless constructions 10 and 13. These subsequent sections of the multi-ply linerless constructions 10 and 13 are separable by releasing the first adhesive pattern 24 from the second release coating 30, which may occur, for example, by pulling the first layer 12 of one section of the multi-ply linerless constructions 10 and 13 from the second layer 14 of a subsequent section of the multi-ply linerless constructions 10 and 13. This may be facilitated by the presence of an area or strip that is free from the adhesive pattern 24 similar to the are or strip 38 on the third face 20 of the second layer 14.

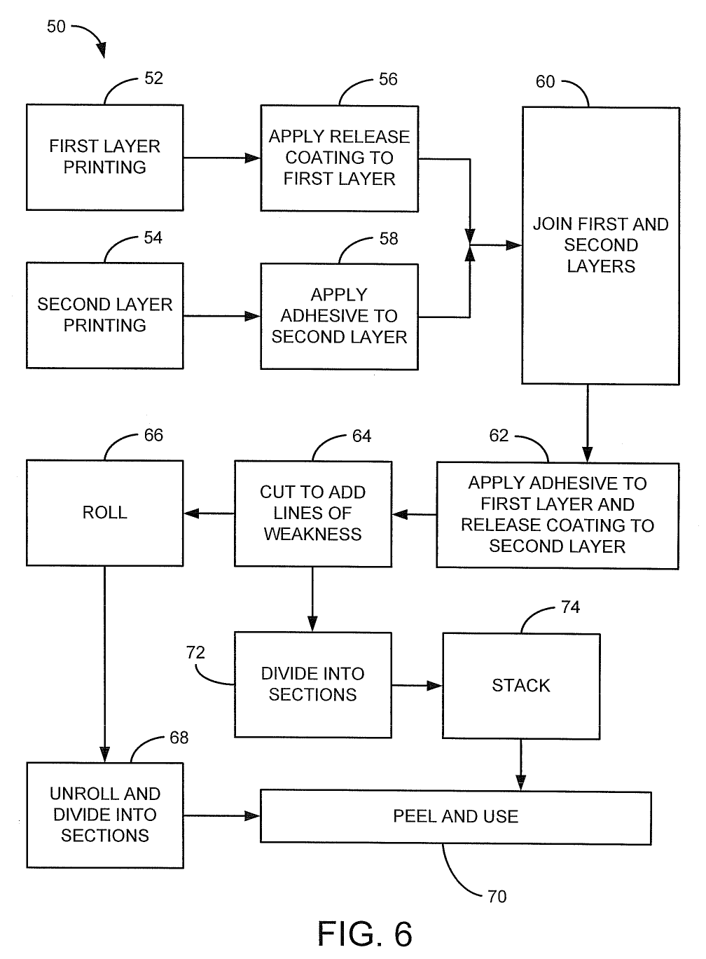

FIG. 6 illustrates a method 50 for producing the example multi-ply linerless construction 10 described herein. The first layer 12 and the second layer 14 are printed on one or both of their respective faces 16, 18, 20 and 22 with textual or graphic information or images (blocks 52 and 54). The first release coating 26 is then applied to the first layer 12 on, for example, an inner face or the second face 18 (block 56). Similarly, the second adhesive pattern 28 is applied to the second layer 14 on, for example, an inner face or the third face 20 (block 58). The release coatings described herein may be, as described above, any known or commercially available release coatings such as, for example, a silicone-based release coating. In addition, the adhesive patterns detailed herein may be implemented using any known or commercially available adhesive(s) such as, for example, a hot melt pressure sensitive adhesive, a repositionable adhesive, a water based-adhesive, a cohesive, and/or fugitive adhesive, etc.

As described above, the first layer 12 and the second layer 14 are joined or married (block 60) by releasably coupling the first release coating 26 to the second adhesive pattern 28. The first layer 12 also has the first adhesive pattern 24 applied to an outer face, or the first face 18, and the second release coating 30 is applied to the second layer 14 at an outer face, or the fourth face 22 (block 62). Although shown in FIG. 6 as occurring after the marrying of the first layer 12 and the second layer 14, the first face 18 and the fourth face 22 may be treated with the first adhesive pattern 24 and the second release coating 30, respectively, before the first layer 12 and the second layer 14 are releasably coupled. When the first adhesive pattern 24, the first release coating 26, the second adhesive pattern 28 and the second release coating 30 are applied (blocks 56, 58 and 62) to one of the first layer 12 or the second layer 14, the patterns or coatings 24, 26, 28 and 30 may be applied to substantially the entire face(s) 16, 18, 20 and 22, or only a portion of the face(s) 16, 18, 20 and 22. In addition, the patterns or coatings 24, 26, 28 and 30 may be applied in strips, dots, or any other pattern or design. Further, any portion of any of the faces 16, 18, 20 and 22 may be substantially free of a pattern or coating. For example, the portion 38 of the third face 20 may be substantially free of the second adhesive pattern 28, as described above.

The multi-ply linerless construction 10 may be cut (block 64) by adding perforations, die cuts, slits, creases, folds, or other lines of weakness 40. After the addition of the lines of weakness 40, the multi-ply linerless construction 10 is divided into sections that may be separated and used as described herein. In alternative examples, the multi-ply linerless construction 10 may remain substantially free of lines of weakness.

After the multi-ply linerless construction 10 is cut (block 64), the multi-ply linerless construction 10 may then be rolled into a large roll (block 66) for transportation or storage, for example. To roll the multi-ply linerless construction 10, the front edge or leading edge of the multi-ply linerless construction 10 is rolled or folded over so that the first adhesive pattern 24 on the first face 16 opposes and is releasably coupled to the second release coating 30 of the fourth face 22.

Once the recipient receives the roll of the multi-ply linerless construction 10, the recipient may unroll the multi-ply linerless construction 10 by separating the first adhesive pattern 24 from the second release coating 30 and divide the multi-ply linerless construction 10 into the sections formed by the lines of weakness 40 (block 68). Thereafter, the first layer 12 and the second layer 14 may be separated as described above, and the first layer 12 and the second layer 14 may be used as the forms for which they were designed together or independently (block 70). Example uses are described above.

Alternatively, upon the creation of the lines of weakness 40 (block 64), the multi-ply linerless construction 10 may be separated or divided into the sections formed by the lines of weakness 10 (block 72) and then sheeted and/or stacked, for example, into a pad (block 74) by releasably coupling or marrying the first adhesive pattern 24 of the first face 16 of the first layer 12 of one section of the multi-ply linerless construction 10 with the second release coating 30 of the fourth face 22 of the second layer 14 of a subsequent section of the multi-ply linerless construction 10. Thereafter, the recipient or end user may separate subsequent sections of the multi-ply linerless construction 10, separate the first layer 12 and the second layer 14 of the same section of the multi-ply linerless construction 10, and use the first layer 12 and/or the second layer as the forms for which they were designed together or independently (block 70).

The method 50 may also include the addition of more layers such as, for example, the third layer 32, a fourth layer, etc. The addition of the third layer 32 (or fourth layer, etc.) may occur throughout the method 50, for example substantially simultaneously with the processing and production of the first layer 12 and the second layer 14. Any additional layers are added and processed in substantially the same manner as the first layer 12 and the second layer 14. For example, the third adhesive pattern 34 is applied to the fifth face of the third layer 32, and the third release coating 36 is applied to the sixth face of the third layer 32. The third adhesive pattern 34 and the third release coating 36 may be formed in any pattern or design as described herein. In addition, the adhesive used in the third adhesive pattern 34 may be any one of the adhesives or cohesives described herein, and the coating used in the third release coating 36 may be any of the coatings described herein.

The third layer 32 may be married to the second layer 14 or the first layer 12. If the third layer 32 is married to the second layer 14, the third adhesive pattern 34 is releasably coupled to the second release coating 30. The first layer 12 and the third layer 32 may then be releasably coupled or married as described above with respect to the marrying of any of the layers 12, 14, and 32. That is, the first layer 12 may be rolled around so the first face 16 of the first layer 12 opposes the sixth face of the third layer 32 to releasably couple the first adhesive pattern 24 with the third release coating 36. Alternatively, if the multi-ply construction 13 has been divided and separated based on the lines of weakness 40, a section of the multi-ply linerless construction 13 that includes the three layers 12, 14 and 32 may be placed atop another section of the multi-ply linerless construction 13 so that the first adhesive pattern 24 of the first face 16 of the first layer 12 of one section of the multi-ply linerless construction 13 is placed on top of the third release coating 36 of the sixth face of the third layer 32 of a subsequent section of the multi-ply linerless construction 13. The subsequent sections of the multi-ply linerless construction 10 and the layers 12, 14 and 32 contained therein, may be separated as described above.

Although certain example methods, apparatus, and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A multi-ply linerless construction comprising:
a first layer including:
a first face, wherein the first face has a first adhesive pattern; and
a second face, wherein the second face has a first release coating;
a second layer including:
a third face, wherein the third face has a second adhesive pattern; and
a fourth face, wherein the fourth face has a second release coating;
wherein the second face and the third face are releasably coupled to releasably couple the first layer and the second layer; and
wherein upon a separation of the first layer and the second layer, each of the first layer and the second layer is a form that provides at least one of graphic images, graphic information, textual images or textual information.

2. A construction as defined in claim 1, wherein the first face and the fourth face are releasably coupled.

3. A construction as defined in claim 2, wherein the construction is rolled.

4. A construction as defined in claim 1, wherein the first adhesive pattern covers substantially all of the first face, the first release coating covers substantially all of the second face, the second adhesive pattern covers substantially all of the third face, and the second release coating covers substantially all of the fourth face.

5. A construction as defined in claim 1, wherein the construction is divided into a plurality of sections by lines of weakness.

6. A construction as defined in claim 5, wherein the lines of weakness include at least one of creases, folds, die-cuts, perforations or slits.

7. A construction as defined in claim 1, further comprising a third layer.

8. A construction as defined in claim 7, wherein the third layer includes:
a fifth face, wherein the fifth face has a third adhesive pattern; and
a six face, wherein the sixth face has a third release coating; and
wherein the fourth face and the fifth face are releasably coupled to releasably couple the second layer and the third layer.

9. A construction as defined in claim 1, wherein at least a portion of at least one of the first layer and the second layer includes a coupon, a reward, a tag, a removable label, a return postcard, and a warranty card.

10. A construction as defined in claim 1, wherein the first layer and the second layer may include information in more than one language.

11. A construction as defined in claim 1, wherein the graphic images and graphic information appear on at least one of the faces.

12. A construction as defined in claim 1, wherein at least a portion of the third face is substantially free of the second adhesive pattern.

13. A construction as defined in claim 12, wherein the portion of the third face that is substantially free of the second adhesive pattern comprises a strip along an edge of the third face.

14. A method of making a multi-ply linerless construction comprising:
applying a first adhesive pattern to a first face of a first layer;
applying a first release coating to a second face of the first layer;
applying a second adhesive pattern to a third face of a second layer;
applying a second release coating to a fourth face of the second layer; and
marrying the second face and the third face to releasably coupled the first layer and the second layer, wherein upon a separation of the first layer and the second layer, each of the first layer and the second layer is a form that provides at least one of graphic images, graphic information, textual images or textual information.

15. A method as defined in claim 14, further comprising marrying the first face and the fourth face.

16. A method as defined in claim 15, further comprising rolling the construction.

17. A method as defined in claim 14, wherein the first adhesive pattern is applied to substantially all of the first face, the first release coating is applied to substantially all of the second face, the second adhesive pattern is applied to substantially all of the third face, and the second release coating is applied to substantially all of the fourth face.

18. A method as defined in claim 14, further comprising dividing the construction into a plurality of sections by lines of weakness.

19. A method as defined in claim 18, further comprising at least one of sheeting the plurality of sections or stacking the plurality of sections into a pad.

20. A method as defined in claim 14, further comprising:
applying a third adhesive pattern to a fifth face of a third layer;
applying a third release coating to a sixth face of the third layer; and
marrying the fourth face and the fifth face to releasably couple the second layer and the third layer.

21. A method as defined in claim 14, further comprising forming into at least a portion of at least one of the first layer and the second layer a coupon, a reward, a tag, a removable label, a return postcard, and or a warranty card.

22. A method as defined in claim 14, further comprising printing the at least one of graphic images or graphic information on at least one of the faces. and second face
